(19) United States
(12) Patent Application Publication
(10) Pub. No.: US 2013/0091446 A1
(43) Pub. Date: Apr. 11, 2013

(54) CUSTOMIZED MULTI-APPLICATION GRAPHICAL WINDOW

(71) Applicants: Murali Neralla, Austin, TX (US); Prasad Venkata Potluri, Austin, TX (US)

(72) Inventors: Murali Neralla, Austin, TX (US); Prasad Venkata Potluri, Austin, TX (US)

(73) Assignee: INTERNATIONAL BUSINESS MACHINES CORPORATION, Armonk, NY (US)

(21) Appl. No.: 13/269,434

(22) Filed: Oct. 7, 2011

(51) Int. Cl. G06F 3/048

(52) U.S. Cl. 715/763

(57) ABSTRACT

A method, programmed medium and system are disclosed which provide the ability to create a customized executable graphical window (CGW) application by selecting desired regions or modules from different base applications. In one example, the system records the location of a selected region of an RGA, creates a CGW to include the selected region of the base RGA application and saves the CGW as a GUI executable application separate from the RGA. The user is enabled to run the CGW as a separate application without the need to switch among the various RGAs of which regions or modules have been included in the CGW.

### FIELD OF THE INVENTION

The present invention relates generally to information processing systems and more particularly to a methodology and implementations for enabling the creation of unique, user-designed graphical user interface (GUI) windows.

### BACKGROUND OF THE INVENTION

The view or appearance of most computer device applications is defined by the application developer. The user of an application may like only a few parts or modules of the application. For example, a user may like calendar module functionality and appearance from a first application, the email client interface from a second application, and a “To Do” interface from a third application. The problem is that the user needs to switch or keep all the applications open, and not minimized, on the desktop to monitor or to work with them. There is no known solution to customize an interface that groups the graphical interfaces of different modules from different applications.

Accordingly, there is a need to provide an improved application display system which is designed to avoid the problems set forth above.

### SUMMARY OF THE INVENTION

A method, programmed medium and system are disclosed which provide the ability to create a customized executable graphical window (CGW) application by selecting desired regions or modules from different base applications. In one example, the system records the location of a selected region of a running graphical application (RGA), and creates a CGW to include the selected region of the base

RGA application and saves the CGW as a GUI executable application separate from the RGA. The user is enabled to run the CGW as a separate application without the need to switch among the various RGAs of which regions or modules have been included in the CGW. In an exemplary embodiment, a user is enabled to select an area of a base application's graphical images by providing an interface to a user for creating a customized graphical window (CGW), selecting a region of a running graphical application (RGA), and choosing a location of the CGW to place in the RGA responsive to the user using the interface. The system is further responsive to running the CGW and detecting the running status of the corresponding base application, getting the selected region of the RGA from one or more of the running base applications, sending user inputs to the base applications, receiving display updates from the base application modules controlling the selected regions, and displaying the display update in the CGW for the selected region of each of the corresponding RGA base applications. The system is still further responsive, in one example, to running the CGW, detecting the absence of the running application, and shading or otherwise marking the display characteristics of the corresponding region of the CGW as “not running” or “inactive”. When one or more of the base to applications is not running, user inputs will not be stored into the CGW when the CGW is closed.

### BRIEF DESCRIPTION OF THE DRAWINGS

A better understanding of the present invention can be obtained when the following detailed description of a preferred embodiment is considered in conjunction with the following drawings, in which:

FIG. 1 is an illustration of one embodiment of a system in which the present invention may be implemented;

FIG. 2 is an illustration of a display screen useful in explaining an exemplary operation of the disclosed system;

FIG. 3 is an illustration of a display screen useful in explaining an exemplary operation of the disclosed system;

FIG. 4 is an illustration of a display screen useful in explaining an exemplary operation of the disclosed system;

FIG. 5 is a flow chart illustrating an exemplary sequence of operations in one embodiment of the present invention;

FIG. 6 is a flow chart illustrating an exemplary sequence of operations in another embodiment of the present invention; and

FIG. 7 is a flow chart illustrating a continuation of the sequence illustrated in FIG. 6.

### DETAILED DESCRIPTION

The various methods discussed herein may be implemented within a computer system which includes, inter alia, processing means, memory, storage means, input means, display means and an operating system and a windows management unit. Since the individual components of a computer system which may be used to implement the functions used in practicing the present invention are generally known in the art and composed of electronic components and circuits which are also generally known to those skilled in the art, circuit details beyond those shown are not specified to any greater extent than that considered necessary as illustrated, for the understanding and appreciation of the underlying concepts of the present invention and in order not to obfuscate or distract from the teachings of the present invention. Although the invention is illustrated in the context of a personal computer system, it is understood that disclosed methodology may also be applied in a more extensive network system as well as in many other available and future devices and systems such as cell phones and personal wireless and other hand-held devices, including any input device, including touch-sensitive screens or touch-sensitive input pads, to achieve the beneficial functional features described herein.

In one exemplary implementation, an interface or tool will be provided to create the Customized Graphical Window (CGW). The tool provides ability to select a module or Region of a Graphical Application (RGA) from a base application when the base application is running. When an RGA is selected, the system records the dimensions and location of the RGA within the base application. The system then provides the ability to choose the location in a CGW template to place the RGA. After completion of adding the RGAs of desired base applications, the CGW can be saved as a GUI executable and represented, for example, as an icon on a desktop display. When the CGW is executed, it communicates with the Windows manager to get the information of the RGAs from already running applications. If an application of a RGA is not running, then that RGA in CGW will be shaded or otherwise marked to indicate an inactive status without any display or input response. For all other RGAs where applications are running, the CGW communicates with the Window Manager to send the user inputs (like keyboard, mouse) to the applications and to receive the display updates from the application.

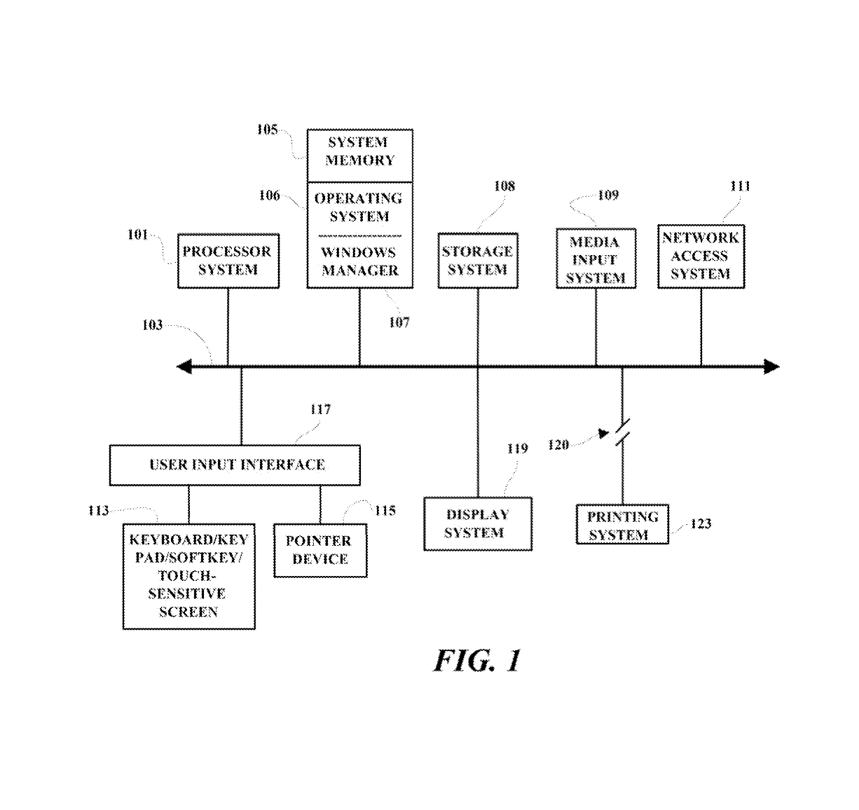

With reference to the drawings, FIG. 1 illustrates an exemplary embodiment in which the present invention may be implemented. As shown, a processor system 101, which may include one or more processors, is connected to a main bus 103. The main bus 103 is also coupled to, inter alfa, system memory 105 including the operating system 106 and a windows manager 107. A local storage system 108, a media input system 109, a network access system 111 and a user input interface 117 are also connected to the main bus 103. The user input interface 117 is arranged to receive user inputs from a keyboard or keypad or softkey device 113 or a pointer device 115 such as a mouse. The main bus 103 is also connected to a display system 119. The input and/or display system may also comprise a touch-sensitive screen or optically-sensitive input pad (not shown). The exemplary system illustrated may also includes a printer device 121, which may be remotely located 120 from the other system components.

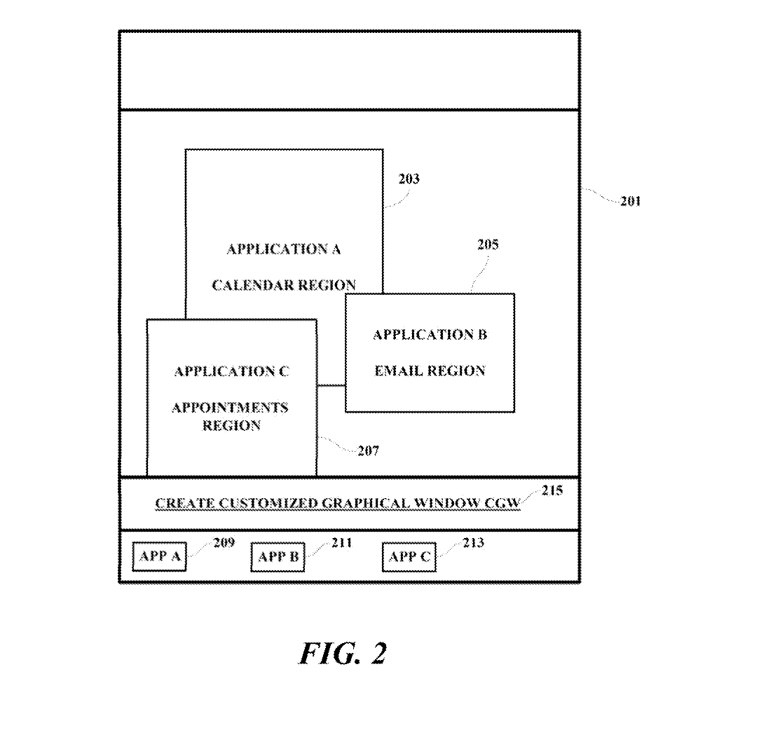

In FIG. 2, there is shown an exemplary display screen 201 showing three different Regions, Calendar, Email and Appointments, respectively, from three different applications A, B, and C, respectively, running in separate windows 203, 205 and 207, respectively. Each of the Regions is running from a different module of a different program. In the example, in the separate windows 203, 205 and 207, a Calendar Region is running from a calendar module of a first application A, an Email Region is running from an Email module of a second application B, and an Appointments Region is running from an appointments module of a third application C. Icons for the three applications or “apps” are represented at the bottom of the display as APP A 209, APP B 211 and APP C 213. Also shown is a hypertext string 215 which may be selected to begin the creation of a Customized Graphical Window CGW using the three applications illustrated.

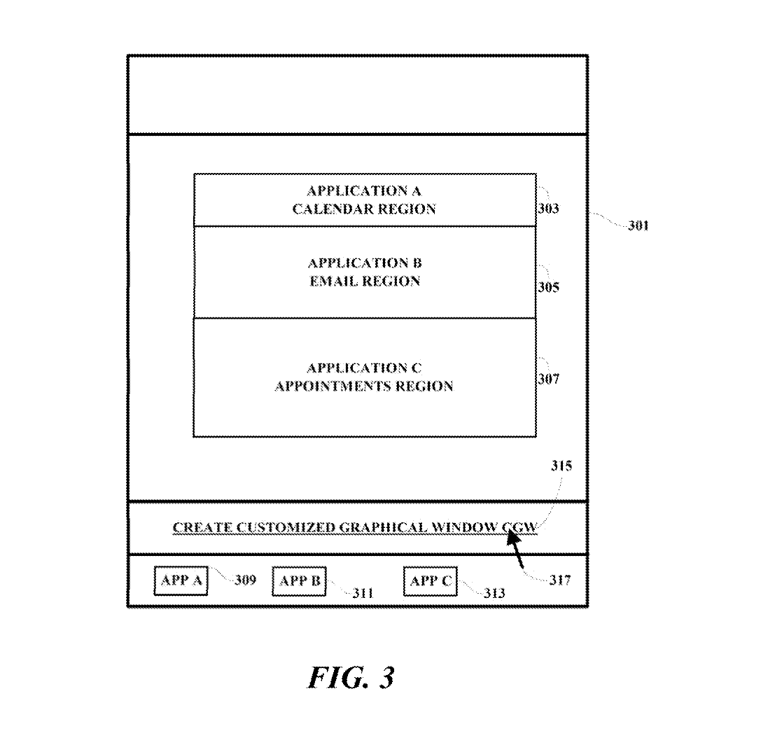

In FIG. 3, the separate Regions from the three application A, B and C are running in separate windows 303, 305 and 307, respectively. Through user input, the corresponding windows 303, 305 and 307 have been moved to locations on the screen 301 preferred by the user. The applications are shown as separately running application Regions. FIG. 3 also shows the separate icons 309, 311 and 313 representing the running programs A, B and C. The running programs A, B and C may be reduced to icon form or expanded from icon form in the normal manner. When a user wishes to create a CGW, the user selects the activation hypertext 315 using a pointer device 317 or other input device such as a finger or other instrument in a system with a touch sensitive input screen.

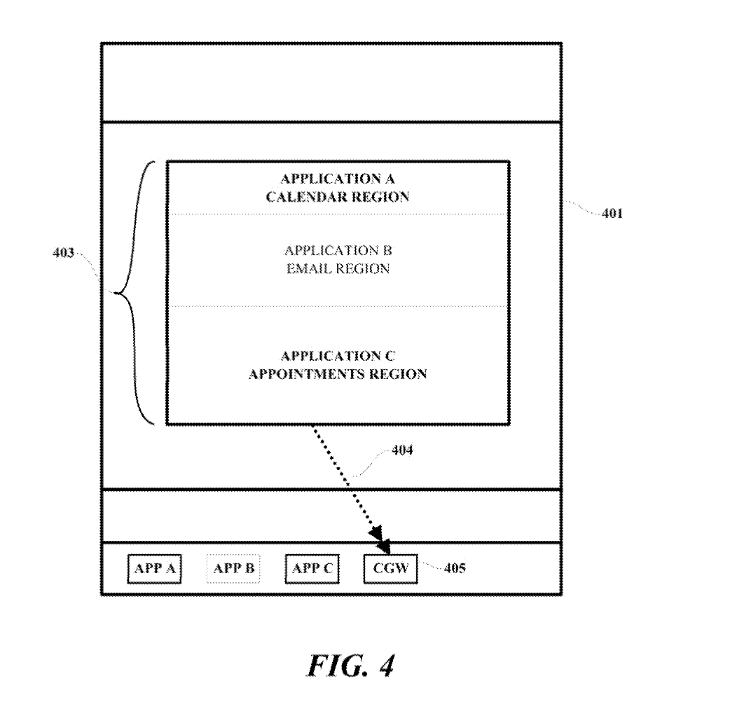

As shown in FIG. 4, after the user has selected to create the CGW, Regions from the three application A, B and C are presented in one window, CGW 403, on the display screen 401. For purposes of illustration, the second application B is shown in dimmed outline which indicates that application B has not been activated and is not running on the computer system while applications A and C are shown in darker or more intense lines to indicate that programs A and C have been activated and are running on the system. As discussed later in greater detail, a user is enabled to input to the displayed Regions within the CGW 403 and the user's input will be displayed as input, but when the user chooses to save or close the CGW 403, the user input will be saved only to the active applications, e.g. A and C, and not to inactive applications or applications which were not running, e.g. B., in FIG. 4. The CGW 403 is created and saved as a separate executable Graphical User Interface GUI application, separate from the base applications A, B and C. The CGW may be reduced 404 to icon form 405 and opened separately from applications A, B and C.

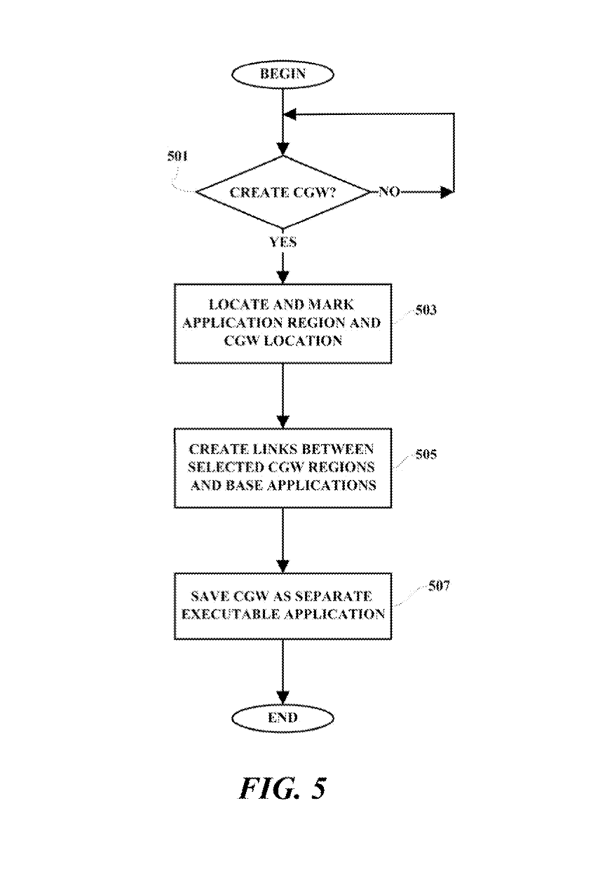

FIG. 5 illustrates an exemplary flow sequence which may be used in creating a CGW. After a user has positioned selected windows containing the preferred Regions and selects to create a CGW 501 as discussed in connection with FIG. 3, the location of the Regions of the selected applications A, B and C are marked and associated with the preferred locations on a CGW template 503. Next, appropriate links are created 505 between the CGW Regions displayed and the base applications A, B and C. The process then saves the created CGW as a separately executable GUI 507.

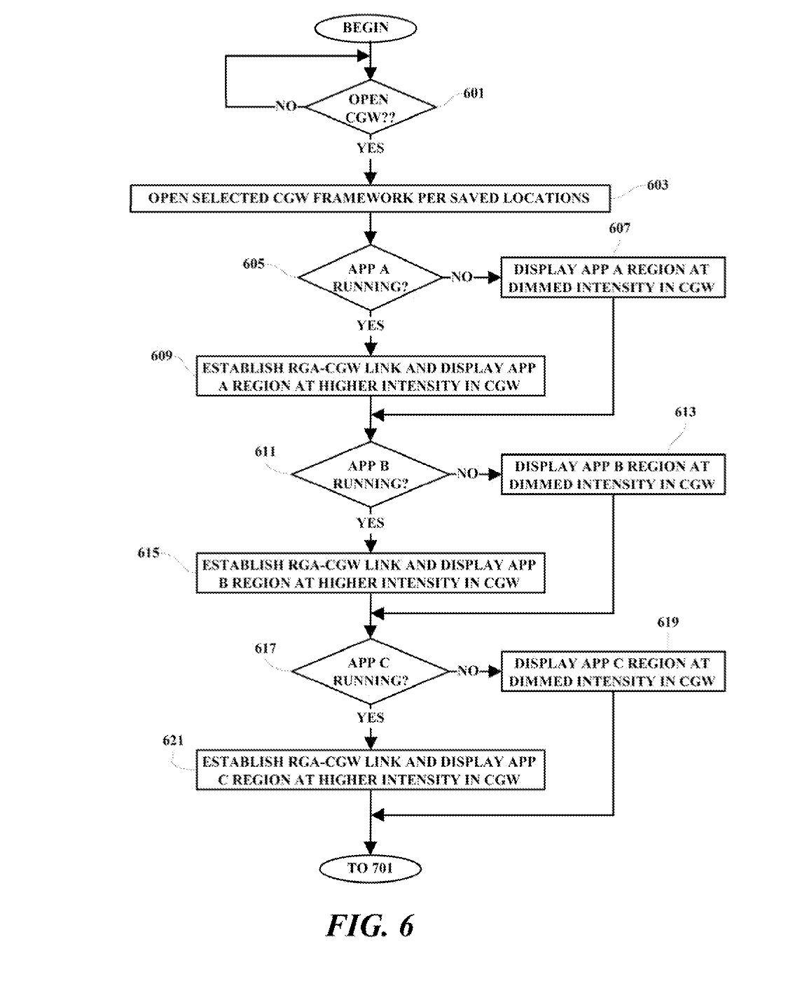

As shown in FIG. 6, when a user opens a CGW 601, the selected CGW framework is retrieved from storage 603. Next, if APP A is running 605, then the display of the APP A Region, i.e. the Calendar Region in the disclosed CGW example, is displayed 609 in a relatively high intensity level compared to the relatively lower “dimmed” intensity level with which the APP A Calendar Region would be displayed 607 if APP A was not running. If it is determined that APP A is running 605, then appropriate RGA-CGW links are also established 609 so that inputs to the CGW display and APP A Calendar Region responses to user inputs will be W able to be properly displayed on the user's display screen. Next, the same process is repeated for APP B, i.e. it is determined if APP B is running 611 and the APP B Email Region is then displayed in either full 615 or dimmed intensity level 613 depending upon the running status of APP B. Appropriate RGA-CGW links are established 615 to allow interfacing between the displayed APP B Email Region in the CGW and the base APP B program module. Next, it is determined if APP C is running 617 and the APP C Appointments Region is then displayed in either full 621 or dimmed intensity level 619 depending upon the running status of APP C. Appropriate RGA-CGW links are also established 621 to allow interfacing between the APP C Appointments Region in the CGW and the base APP C program module for the Appointments function.

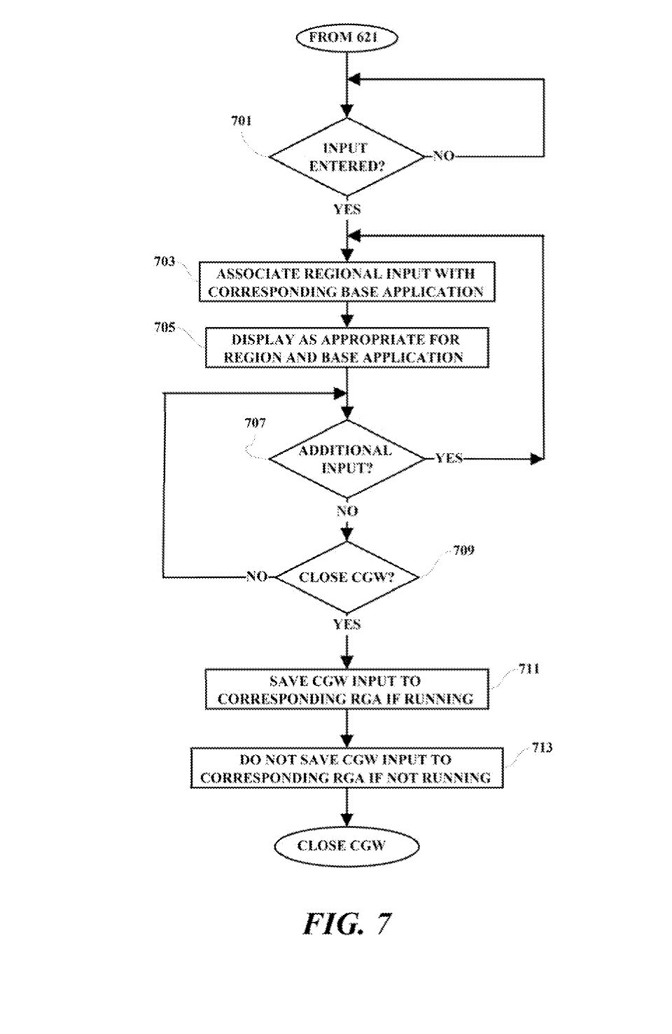

In FIG. 7, when input is entered 701 to the CGW by the user, the Regional input is associated with the corresponding base application 703 and displayed 705 in accordance with the base application module controlling the corresponding Region. The process is repeated for additional input 707 and when the user selects to close the CGW 709, the CGW inputs are saved 711 to the corresponding applications for running applications but the user inputs to inactive or not running applications are not saved 713, and the CGW is closed.

The flowchart and block diagrams illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It is understood that the specific example presented herein is not intended to be limiting since the functional combinations disclosed herein may be implemented in many different environments and applications including, for example, applications involving the visualization of business processes and movement of emails, task lists, task list items and other system data components within an overall system data containment environment or application.

The method, system and apparatus of the present invention has been described in connection with a preferred embodiment as disclosed herein. The disclosed methodology may be implemented in a wide range of sequences, menus and screen designs to accomplish the desired results as herein illustrated. Although an embodiment of the present invention has been shown and described in detail herein, along with certain variants thereof, many other varied embodiments that incorporate the teachings of the invention may be easily constructed by those skilled in the art, and even included or integrated into a processor or CPU or other larger system integrated circuit or chip. The disclosed methodology may also be implemented solely or partially in program code stored on a computer program product comprising a computer-readable, tangible storage device(s) and computer-readable program instructions stored on the computer-readable, tangible storage device(s) in any media, including any portable or fixed, volatile or non-volatile memory media device, including CDs, RAM and “Flash” memory, or other semiconductor, optical, magnetic or other memory media capable of storing code. The disclosed methodology may also be implemented using any available input and/or display systems including touch-sensitive screens and optically-sensitive input pads. Accordingly, the present invention is not intended to be limited to the specific form set forth herein, but on the contrary, it is intended to cover such alternatives, modifications, and equivalents, as can be reasonably included within the spirit and scope of the invention.

What is claimed is:

1. A method for creating a customized executable graphical window interface application from selected displayed regions of two or more base applications, said method comprising:
displaying selected regions from two or more regions of base applications;
enabling a receipt of user input for determining a location of windows containing said selected regions on a user display screen;
saving said locations of said selected windows on said user display screen;
creating links between said selected regions and said base applications containing said regions to enable communication between said selected regions in said selected windows and corresponding base applications;
creating a customized graphics window (CGW) application containing said selected windows; and
enabling a saving of said CGW application as a separate executable application, separate from said base applications.

2. The method as set forth in claim 1 and further including:
enabling an opening of said CGW application in response to a user input;
determining base programs associated with said selected regions in said CGW application;
determining a running status of said base programs;
activating said links between said selected regions and said associated base programs to interfacing between input to said selected regions and said corresponding base programs; and
modifying display characteristics of said selected regions within said selected windows depending upon a running status of said corresponding base programs.

3. The method as set forth in claim 2 wherein said modified display characteristics include a displayed brightness intensity of said selected regions.

4. The method as set forth in claim 3 wherein regions associated with running base programs are illuminated with a different brightness intensity than regions associated with base programs which are not running.

5. The method as set forth in claim 4 wherein regions associated with base programs which are running are illuminated at a higher brightness intensity than regions associated with base programs which are not running.

6. The method as set forth in claim 2 and further including:
enabling receipt of user input to said selected regions of said CGW application;
responding to said user input to said selected regions as determined by said corresponding base program associated with said selected region; and
enabling a storing of said user input to a selected region to a base program associated with said selected region only if said associated base program is running.

7. The method as set forth in claim 6 and further including not storing user input to a selected region to a base program associated with said selected region if said associated base program is not running.

8. A computer program product comprising a computer-readable, tangible storage device(s) and computer-readable program instructions stored on the computer-readable, tangible storage device(s) for creating a customized executable graphical window interface application from selected displayed regions of two or more base applications, the computer-readable program instructions, when executed by a processing system, being operable for implementing a method comprising:
displaying selected regions from two or more regions of base applications;
enabling a receipt of user input for determining a location of windows containing said selected regions on a user display screen;
saving said locations of said selected windows on said user display screen;
creating links between said selected regions and said base applications containing said regions to enable communication between said selected regions in said selected windows and corresponding base applications;
creating a customized graphics window (CGW) application containing said selected windows; and
enabling a saving of said CGW application as a separate executable application, separate from said base applications.

9. The computer program product as set forth in claim 8 wherein said method further includes;
enabling an opening of said CGW application in response to a user input;
determining base programs associated with said selected regions in said CGW application;
determining a running status of said base programs;
activating said links between said selected regions and said associated base programs to interfacing between input to said selected regions and said corresponding base programs; and
modifying display characteristics of said selected regions within said selected windows depending upon a running status of said corresponding base programs.

10. The computer program product as set forth in claim 9 wherein said modified display characteristics include a displayed brightness intensity of said selected regions.

11. The computer program product as set forth in claim 10 wherein regions associated with running base programs are illuminated with a different brightness intensity than regions associated with base programs which are not running.

12. The computer program product as set forth in claim 11 wherein regions associated with base programs which are running are illuminated at a higher brightness intensity than regions associated with base programs which are not running.

13. The computer program product as set forth in claim 9 wherein said method further includes:
enabling receipt of user input to said selected regions of said CGW application;
responding to said user input to said selected regions as determined by said corresponding base program associated with said selected region; and
enabling a storing of said user input to a selected region to a base program associated with said selected region only if said associated base program is running.

14. The computer program product as set forth in claim 13 wherein said method further includes not storing user input to a selected region to a base program associated with said selected region if said associated base program is not running.

15. A system for creating a customized executable graphical window interface application from selected displayed regions of two or more base applications, said system comprising:
a display device for displaying selected regions from two or more regions of base applications;
means for enabling a receipt of user input for determining a location of windows containing said selected regions on a user display screen;
means for saving said locations of said selected windows on said user display screen;
means for creating links between said selected regions and said base applications containing said regions to enable communication between said selected regions in said selected windows and corresponding base applications;
means for creating a customized graphics window (CGW) application containing said selected windows; and
means for enabling a saving of said CGW application as a separate executable application, separate from said base applications.

16. The system as set forth in claim 15 and further including:
means for enabling an opening of said CGW application in response to a user input;
means for determining base programs associated with said selected regions in said CGW application;
means for determining a running status of said base programs;
means for activating said links between said selected regions and said associated base programs to interfacing between input to said selected regions and said corresponding base programs; and
means for modifying display characteristics of said selected regions within said selected windows depending upon a running status of said corresponding base programs.

17. The system as set forth in claim 16 wherein said modified display characteristics include a displayed brightness intensity of said selected regions.

18. The system as set forth in claim 17 wherein regions associated with running base programs are illuminated with a different brightness intensity than regions associated with base programs which are not running.

19. The system as set forth in claim 18 wherein regions associated with base programs which are running are illuminated at a higher brightness intensity than regions associated with base programs which are not running.

20. The system as set forth in claim 16 and further including:
means for enabling receipt of user input to said selected regions of said CGW application;
means for responding to said user input to said selected regions as determined by said corresponding base program associated with said selected region; and
means for enabling a storing of said user input to a selected region to a base program associated with said selected region only if said associated base program is running.
